(19) United States
(12) Patent Application Publication
(10) Pub. No.: US 2026/0104215 A1
(43) Pub. Date: Apr. 16, 2026

(54) COOLING APPARATUS AND IMAGE FORMING APPARATUS

(71) Applicant: KYOCERA Document Solutions Inc., Osaka-shi (JP)

(72) Inventor: Shimon Tasaka, Osaka (JP)

(21) Appl. No.: 19/351,815

(22) Filed: Oct. 7, 2025

(30) Foreign Application Priority Data
Oct. 10, 2024 (JP) 2024-177929

(51) Int. Cl. F28F 9/22; B41J 2/17; B41J 29/377

(52) U.S. Cl. CPC F28F 9/22; B41J 2/1728; B41J 29/377

(57) ABSTRACT

A cooling apparatus includes a main tank and a replenishment apparatus that replenishes a refrigerant liquid in the main tank, a waste liquid tank, a waste liquid pipe, and a liquid detection apparatus. The waste liquid tank is arranged at a position lower than the main tank. The waste liquid pipe is connected to a discharge port formed in the main tank and forms a flow channel extending to the waste liquid tank from the discharge port via a specific position. The liquid detection apparatus detects the refrigerant liquid in the waste liquid pipe at the specific position. The specific position is a position higher than the discharge port and lower than an upper end of a region capable of storing the refrigerant liquid in the main tank.

### INCORPORATION BY REFERENCE

This application is based upon and claims the benefit of priority from the corresponding Japanese Patent Application No. 2024-177929 filed on October 10, 2024, the entire contents of which are incorporated herein by reference.

### BACKGROUND

The present disclosure relates to a cooling apparatus that cools a cooling target with a refrigerant liquid and an image forming apparatus.

An apparatus that constitutes the image forming apparatus tends to have a high temperature due to the increasing speed of print processing.

In view of this, the image forming apparatus may include a cooling apparatus. For example, it is known that an electrophotographic image forming apparatus includes a liquid cooling type cooling apparatus that cools a developing apparatus.

### SUMMARY

A cooling apparatus according to an aspect of the present disclosure includes a main tank that stores a refrigerant liquid and a replenishment apparatus that replenishes the refrigerant liquid in the main tank, which circulates the refrigerant liquid in a circulation path including the main tank and a cooling target, thereby cooling the cooling target. The cooling apparatus includes a waste liquid tank, a waste liquid pipe, and a liquid detection apparatus. The waste liquid tank is arranged at a position lower than the main tank and is capable of storing the refrigerant liquid. The waste liquid pipe is connected to a discharge port formed in the main tank and forms a flow channel extending to the waste liquid tank from the discharge port via a specific position. The liquid detection apparatus detects the refrigerant liquid in the waste liquid pipe at the specific position. The specific position is a position higher than the discharge port and lower than an upper end of a region capable of storing the refrigerant liquid in the main tank.

An image forming apparatus according to another aspect of the present disclosure includes: a print apparatus that forms an image on a sheet; and the above-mentioned cooling apparatus that cools a portion of the print apparatus.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF FIGURES

FIG. 1 is a configuration diagram of an image forming apparatus according to an embodiment.

FIG. 2 is a diagram showing an image forming apparatus when a nozzle cover apparatus is in a nozzle close state.

FIG. 3 is a block diagram showing a configuration of a control apparatus in the image forming apparatus according to the embodiment.

FIG. 4 is a configuration diagram of a main cooling unit of a cooling apparatus in the image forming apparatus according to the embodiment.

### DETAILED DESCRIPTION

Embodiments of the present disclosure will be described below with reference to the drawings. Note that the following embodiments are merely examples embodying the present disclosure and do not limit the technical scope of the present disclosure.

An image forming apparatus 10 according to an embodiment includes a print apparatus 4 that executes print processing of forming an image on a sheet 9. In the present embodiment, the print apparatus 4 executes the print processing using an inkjet method.

For example, the image forming apparatus 10 is a printer, a facsimile apparatus, a copying machine, a multifunction peripheral, or other apparatus. The sheet 9 is a sheet-like image forming medium such as paper or resin film.

### Configuration of image forming apparatus 10

The image forming apparatus 10 includes a sheet accommodation part 12, a sheet conveyance apparatus 3, a print apparatus 4, and an ink supply apparatus 40.

The sheet conveyance apparatus 3, the print apparatus 4, the ink supply apparatus 40, and a control apparatus 8 are housed in a main body 1 of the image forming apparatus 10.

The sheet conveyance apparatus 3 conveys the sheets 9 housed in the sheet accommodation part 12 along a sheet conveyance path 30 one by one. The sheet conveyance apparatus 3 includes a feeding apparatus 31, a first belt conveyance apparatus 32, a second belt conveyance apparatus 33, and a discharge conveyance apparatus 34.

The feeding apparatus 31 feeds the sheets 9 from the sheet accommodation part 12 to the sheet conveyance path 30 one by one and further conveys the sheets 9 to the first belt conveyance apparatus 32.

The first belt conveyance apparatus 32 takes over the conveyance of the sheet 9 from the feeding apparatus 31 and further conveys the sheet 9 to the second belt conveyance apparatus 33.

The second belt conveyance apparatus 33 takes over the conveyance of the sheet 9 from the first belt conveyance apparatus 32 and further conveys the sheet 9 to the discharge conveyance apparatus 34.

The discharge conveyance apparatus 34 takes over the conveyance of the sheet 9 from the second belt conveyance apparatus 33 and feeds the image-formed sheet 9 out of the main body 1. For example, the discharge conveyance apparatus 34 feeds the sheet 9 to a discharge tray or another apparatus at the subsequent stage.

The print apparatus 4 includes a plurality of inkjet heads 4x corresponding to a plurality of development colors. Each of the inkjet heads 4x has ink ejection parts 4a including a plurality of nozzles that eject ink. Each of the inkjet heads 4x ejects ink onto the sheet 9 to form an image on the sheet 9.

The ink supply apparatus 40 supplies ink of different colors to each of the plurality of inkjet heads 4x. In the present embodiment, the print apparatus 4 includes four inkjet heads 4x corresponding to the four colors of ink: black, cyan, magenta, and yellow.

The image forming apparatus 10 further includes a nozzle cover apparatus 5 and a waste ink collection apparatus 6. The nozzle cover apparatus 5 has a plurality of caps 51 covering the ink ejection parts 4a of the plurality of inkjet heads 4x.

The nozzle cover apparatus 5 is capable of switching between a nozzle close state in which the ink ejection parts 4a of the plurality of inkjet heads 4x are covered by the plurality of caps 51 and a nozzle open state in which the ink ejection parts 4a of the plurality of inkjet heads 4x are opened.

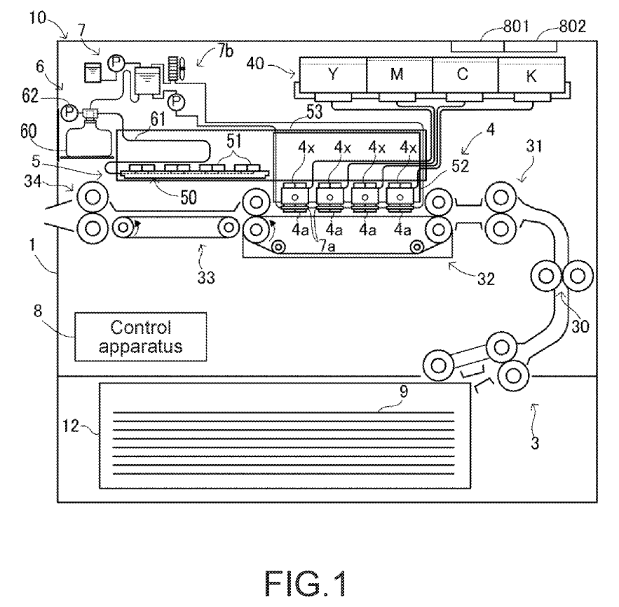

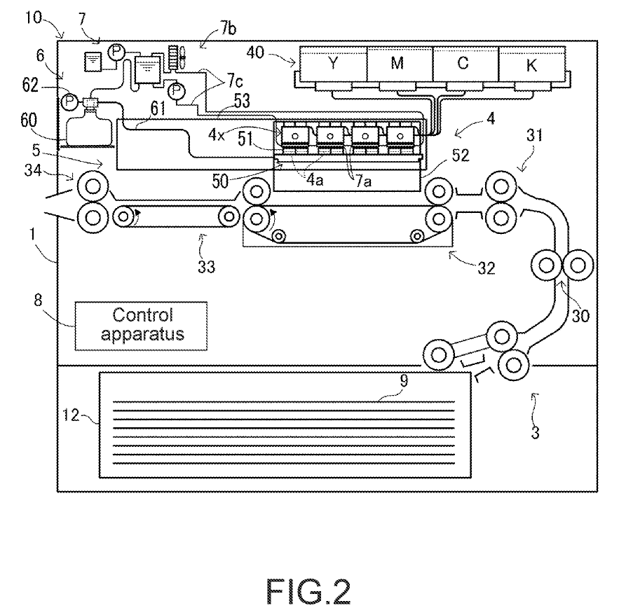

FIG. 1 shows the image forming apparatus 10 when the nozzle cover apparatus 5 is in the nozzle open state. FIG. 2 shows the image forming apparatus 10 when the nozzle cover apparatus 5 is in the nozzle close state.

For example, the nozzle cover apparatus 5 includes a cap unit 50, a head moving apparatus 52, and a cap moving apparatus 53. The cap unit 50 includes the plurality of caps 51.

The head moving apparatus 52 moves the plurality of inkjet heads 4x between a print position and a maintenance position. The print position is a position along a conveyor belt of the first belt conveyance device 32 (see FIG. 1). The plurality of inkjet heads 4x are capable of performing the print processing when they are in the print position.

The maintenance position is a position further away from the first belt conveyance device 32 than the print position (see FIG. 2). When the plurality of inkjet heads 4x is present at the maintenance position, a space in which the cap unit 50 can be inserted is formed between the ink ejection parts 4a of the plurality of inkjet heads 4x and the first belt conveyance apparatus 32.

The cap moving apparatus 53 moves the cap unit 50 between a cap position and an evacuation position. The cap position is the position of the cap unit 50 when the plurality of caps 51 covers the ink ejection parts 4a of the plurality of inkjet heads 4x. The evacuation position is a position further away from the plurality of inkjet heads 4x than the cap position.

When the plurality of inkjet heads 4x is present at the maintenance position, the cap moving apparatus 53 can move the cap unit 50 between the evacuation position and the cap position. When the cap unit 50 is present at the evacuation position, the head moving apparatus 52 can move the plurality of inkjet heads 4x between the print position and the maintenance position.

The waste ink collection apparatus 6 is an apparatus that collects waste ink generated in the print apparatus 4 to a waste ink tank 60. In the present embodiment, the waste ink is ink ejected into the plurality of caps 51 from the ink ejection parts 4a of the plurality of inkjet heads 4x when the nozzle cover apparatus 5 is in the nozzle close state.

The waste ink collection apparatus 6 includes the waste ink tank 60, a collection tube 61 that connects the cap unit 50 and the waste ink tank 60, and a suction pump 62. The inside of the plurality of caps 51 and the waste ink tank 60 are in communication through the collection tube 61.

The suction pump 62 conveys the waste ink in the plurality of caps 51 into the waste ink tank 60 through the collection tube 61 by reducing the pressure in the waste ink tank 60 to a negative pressure.

For example, the image forming apparatus 10 further includes an operation apparatus 801, a display apparatus 802, and the control apparatus 8 (see FIG. 1).

The operation apparatus 801 is an apparatus that receives human operations. For example, the operation apparatus 801 includes operation buttons and a touch panel. The display apparatus 802 is capable of displaying information. For example, the display apparatus 802 includes a display panel such as a liquid-crystal panel.

The control apparatus 8 executes various types of data processing and control on the apparatuses of the image forming apparatus 10.

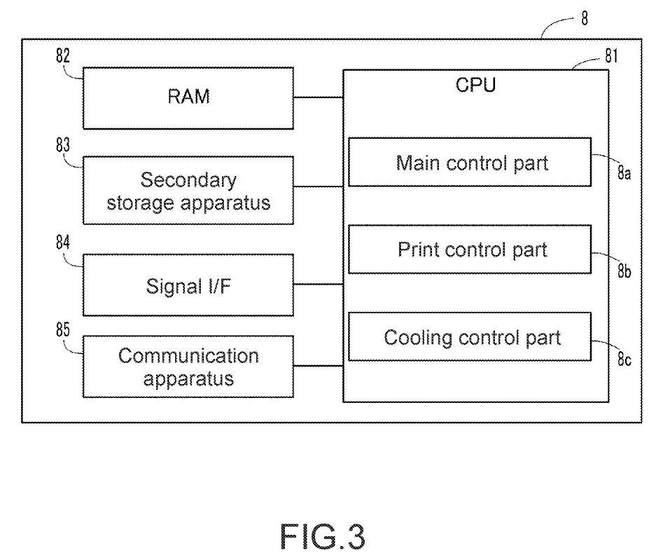

As shown in FIG. 3, for example, the control apparatus 8 includes a central processing unit (CPU) 81, a random access memory (RAM) 82, a secondary storage apparatus 83, a signal interface 84, and a communication apparatus 85.

The CPU 81 is an example of a processor that executes various types of data processing and control by executing a computer program.

The RAM 82 is a computer-readable volatile storage apparatus. The RAM 82 temporarily stores the computer program executed by the CPU 81 and data output and referenced in the process in which the CPU 81 executes various types of processing.

The secondary storage apparatus 83 is a computer-readable nonvolatile storage apparatus. The secondary storage apparatus 83 is capable of storing and updating the computer program and various types of data. For example, some or all of flash memory, solid state drive (SSD), and hard disk drive are employed as the secondary storage apparatus 83.

The signal interface 84 converts signals output by various sensors into digital data and transmits the converted digital data to the CPU 81. In addition, the signal interface 84 converts control commands output by the CPU 81 into control signals and transmits the control signals to an apparatus to be controlled.

The communication apparatus 85 capable of communicating with a host apparatus (not shown) and other apparatuses. The host apparatus is an information processing apparatus such as a personal computer or smartphone operated by a user.

For example, the CPU 81 receives a print job from the host apparatus through the communication apparatus 85. The print apparatus 4 forms an image determined by the print job on the sheet 9.

The CPU 81 includes a plurality of processing modules realized by executing the computer program. For example, the plurality of processing modules includes a main control part 8a and a print control part 8b.

The main control part 8a executes control to start various types of processing in accordance with operations on the operation apparatus 801 and control of the display apparatus 802.

The print control part 8b causes the sheet conveyance apparatus 3 to perform sheet conveyance processing. In addition, the print control unit 8b causes the print apparatus 4 to execute the print processing in synchronization with the conveyance of the sheet 9 by the sheet conveyance apparatus 3.

The image forming apparatus 10 further includes with a liquid cooling type cooling apparatus 7 that cools a portion of the print apparatus 4 (see FIGS. 1 and 3). The plurality of processing modules of the CPU 81 includes a cooling control part 8c that controls the cooling apparatus 7.

By the way, the liquid cooling type cooling apparatus 7 includes a main tank 70 that stores a refrigerant liquid, and circulates the refrigerant liquid in a circulation path that includes the main tank 70 and a cooling target, thereby cooling the cooling target. For example, the refrigerant liquid is water.

In the present embodiment, the cooling target is the plurality of inkjet heads 4x in the print apparatus 4.

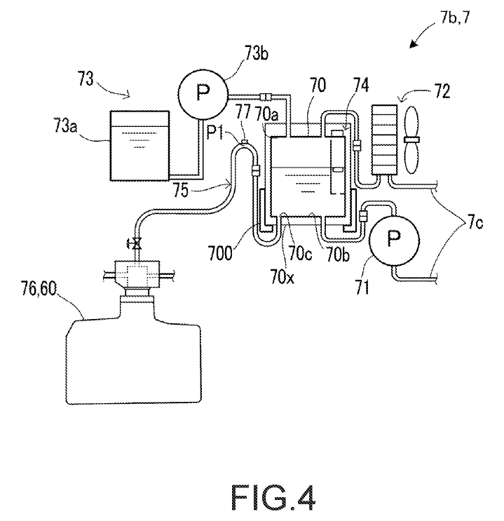

In addition, the cooling apparatus 7 includes a liquid level gauge 74 that detects the liquid level in the main tank 70 and a replenishment apparatus 73 that replenishes the refrigerant liquid in the main tank 70 (see FIG. 4). The replenishment apparatus 73 operates so that the liquid level detected by the liquid level gauge 74 is maintained at a reference level.

In the present embodiment, the cooling control part 8c operates the replenishment apparatus 73 when the liquid level detected by the liquid level gauge 74 falls below the reference level. On the other hand, the cooling control part 8c stops the operation of the replenishment apparatus 73 when the liquid level detected by the liquid level gauge 74 does not fall below the reference level.

In the cooling apparatus 7, the liquid level in the main tank 70 may exceed an allowable range when an apparatus abnormality such as a failure of the replenishment apparatus 73 occurs. Replacement of the unit including the abnormal apparatus is desirably performed under the condition that the tank is empty.

On the other hand, it is undesirable to provide a pump to discharge the refrigerant liquid from the main tank 70 because this will increase costs.

The cooling apparatus 7 includes a configuration for discharging the refrigerant liquid from the main tank 70 without the use of a pump when a situation occurs where the liquid level in the main tank 70 exceeds an allowable range.

The cooling apparatus 7 includes heat exchange parts 7a, a main cooling unit 7b, and a plurality of circulation tubes 7c. The main cooling unit 7b includes the main tank 70, a circulation pump 71, a radiator 72, the replenishment apparatus 73, and the liquid level gauge 74.

The heat exchange parts 7a exchange heat between the refrigerant liquid and the plurality of inkjet heads 4x. Accordingly, the heat exchange part 7a cools each of the inkjet heads 4x, which have a higher temperature than the refrigerant liquid.

The plurality of circulation tubes 7c connects the main tank 70, the heat exchange parts 7a, the radiator 72, and the circulation pump 71 to form a circulation path for the refrigerant liquid. The circulation pump 71 circulates the refrigerant liquid in the main tank 70 within the circulation path.

The circulation pump 71 circulates the refrigerant liquid in the circulation path. That is, the circulation pump 71 circulates the refrigerant liquid to the main tank 70, the heat exchange parts 7a, and the radiator 72. The radiator 72 radiates the heat of the refrigerant liquid.

In the present embodiment, the liquid level gauge 74 is a float type water level gauge. The liquid level gauge 74 is an example of a liquid level detection apparatus that detects the liquid level in the main tank 70.

The replenishment apparatus 73 includes an auxiliary tank 73a and a replenishment pump 73b. The auxiliary tank 73a contains the refrigerant liquid. The replenishment pump 73b pumps the refrigerant liquid in the auxiliary tank 73a to the main tank 70. In the present embodiment, the replenishment pump 73b is a diaphragm pump.

The liquid level gauge 74 detects whether the level of the refrigerant liquid in the main tank 70 meets or falls below the reference level. When the liquid level gauge 74 detects that the level of the refrigerant liquid in the main tank 70 is below the reference level, the replenishment pump 73b operates.

The cooling system 7 further includes a waste liquid pipe 75, a waste liquid tank 76 capable of storing the refrigerant liquid, and a liquid detection sensor 77 (see FIG. 4).

The waste liquid tank 76 is arranged at a position lower than the main tank 70. In the present embodiment, the waste ink tank 60 also serves as the waste liquid tank 76. By reduction, the waste liquid tank 76 also serves as the waste ink tank 60.

The waste liquid pipe 75 is connected to a discharge port 70c formed in the main tank 70 to form a flow path of the refrigerant liquid, which extends to the waste liquid tank 76 from the discharge port 70c via a specific position P1. The cross-sectional area of the waste liquid pipe 75 is smaller than the cross-sectional area of the main tank 70.

The specific position P1 is the highest position in the path of the waste liquid pipe 75. That is, portions of the waste liquid pipe 75 other than the specific position P1 are arranged at a position lower than the specific position P1.

The liquid detection sensor 77 detects the refrigerant liquid in the waste liquid pipe 75 at the specific position P1. For example, the liquid detection sensor 77 is a capacitive level switch or an electrode level switch. The liquid detection sensor 77 is an example of the liquid detection apparatus a liquid detection apparatus.

The specific position P1 is a position higher than the discharge port 70c and lower than an upper end 70a of the region capable of storing the refrigerant liquid in the main tank 70. The position of the upper end 70a of that region is a position higher than the reference level.

The liquid level in the waste liquid pipe 75 is the same as the liquid level in the main tank 70. The liquid detection sensor 77 detects that the level of the refrigerant liquid in the main tank 70 has reached the upper limit.

The liquid level gauge 74 detects a liquid level lower than the specific position P1 in the main tank 70. That is, the reference level is lower than the specific position P1. Therefore, when the cooling apparatus 7 is operating normally, the level of the refrigerant liquid does not rise to the specific position P1.

In a case where the replenishment pump 73b runs out of control due to an abnormality of the replenishment pump 73b or the liquid level gauge 74, the level of the refrigerant liquid in the main tank 70 reaches the upper limit and the liquid detection sensor 77 detects the refrigerant liquid at the specific position P1. In addition, when the refrigerant liquid flows toward the waste liquid tank 76 beyond the specific position P1, the refrigerant liquid in the main tank 70 is discharged to the waste liquid tank 76 by the siphon phenomenon.

In the present embodiment, the discharge port 70c is formed on a bottom surface 70b of the main tank 70 (see FIG. 4). Moreover, the waste liquid tank 76 is arranged at a position lower than the bottom surface 70b of the main tank 70. This allows all the refrigerant liquid in the main tank 70 to be discharged to the waste liquid tank 76.

The cooling control part 8c executes error processing when the refrigerant liquid at the specific position P1 is detected by the liquid detection sensor 77. The error processing includes processing of stopping the replenishment pump 73b and the circulation pump 71 and processing of outputting an alarm through one or both of the display apparatus 802 and the communication apparatus 85. The display apparatus 802 and the communication apparatus 85 are examples of output apparatuses.

In the present embodiment, the cooling apparatus 7 includes a tank unit 70x and a unit mounting part 700 (see FIG. 4). The tank unit 70x includes the main tank 70 and the liquid level gauge 74. The unit mounting part 700 is arranged in the main body 1. The tank unit 70x is removably mounted on the unit mounting part 700.

In a case where the liquid level gauge 74 is a float type water level gauge, the liquid level gauge 74 is likely to fail when the level of the refrigerant liquid in the main tank 70 reaches the upper limit. In the present embodiment, when the liquid level gauge 74 fails, the tank unit 70x to which the liquid level gauge 74 is attached can be easily replaced in the state in which the main tank 70 is empty.

### Notes of disclosure

The outline of the invention extracted from the above-mentioned embodiments will be given below. Note that the configurations and processing functions described in the following notes can be arbitrarily selected and combined.

### Note 1

A cooling apparatus with a main tank that stores a refrigerant liquid and a replenishment apparatus that replenishes the refrigerant liquid in the main tank, which circulates the refrigerant liquid in a circulation path including the main tank and a cooling target, thereby cooling the cooling target, including:

a waste liquid tank that is arranged at a position lower than the main tank and is capable of storing the refrigerant liquid;

a waste liquid pipe that is connected to a discharge port formed in the main tank and forms a flow channel extending to the waste liquid tank from the discharge port via a specific position; and a liquid detection apparatus that detects the refrigerant liquid in the waste liquid pipe at the specific position, in which the specific position is a position higher than the discharge port and lower than an upper end of a region capable of storing the refrigerant liquid in the main tank.

### Note 2

The cooling apparatus according to Note 1, in which the discharge port is formed on a bottom surface of the main tank, and the waste liquid tank is arranged at a position lower than the bottom surface of the main tank.

### Note 3

The cooling apparatus according to Note 1 or 2, further including a unit mounting part on which a tank unit including the main tank is removably mounted.

### Note 4

The cooling apparatus according to Note 3, further including

a liquid level detection apparatus that detects a liquid level in the main tank, the liquid level being lower than the specific position, in which the tank unit includes the main tank and the liquid level detection apparatus.

### Note 5

The cooling apparatus according to any one of Notes 1 to 4, in which the cooling target includes an inkjet head that ejects ink onto a sheet, thereby forming an image on the sheet, and the waste liquid tank also serves as a waste ink tank that contains the waste ink in a waste ink collection apparatus that collects waste ink generated in the inkjet head.

### Note 6

An image forming apparatus, including:

a print apparatus that forms an image on a sheet; and a cooling apparatus according to any one of Notes 1 to 5 that cools a portion of the print apparatus.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A cooling apparatus with a main tank that stores a refrigerant liquid and a replenishment apparatus that replenishes the refrigerant liquid in the main tank, which circulates the refrigerant liquid in a circulation path including the main tank and a cooling target, thereby cooling the cooling target, comprising:
a waste liquid tank that is arranged at a position lower than the main tank and is capable of storing the refrigerant liquid;
a waste liquid pipe that is connected to a discharge port formed in the main tank and forms a flow channel extending to the waste liquid tank from the discharge port via a specific position; and
a liquid detection apparatus that detects the refrigerant liquid in the waste liquid pipe at the specific position, wherein
the specific position is a position higher than the discharge port and lower than an upper end of a region capable of storing the refrigerant liquid in the main tank.

2. The cooling apparatus according to claim 1, wherein
the discharge port is formed on a bottom surface of the main tank, and
the waste liquid tank is arranged at a position lower than the bottom surface of the main tank.

3. The cooling apparatus according to claim 1, further comprising
a unit mounting part on which a tank unit including the main tank is removably mounted.

4. The cooling apparatus according to claim 3, further comprising
a liquid level detection apparatus that detects a liquid level in the main tank, the liquid level being lower than the specific position, wherein
the tank unit includes the main tank and the liquid level detection apparatus.

5. The cooling apparatus according to claim 1, wherein
the cooling target includes an inkjet head that ejects ink onto a sheet, thereby forming an image on the sheet, and
the waste liquid tank also serves as a waste ink tank that contains the waste ink in a waste ink collection apparatus that collects waste ink generated in the inkjet head.

6. An image forming apparatus, comprising:
a print apparatus that forms an image on a sheet; and
a cooling apparatus according to claim 1 that cools a portion of the print apparatus.
